(19) United States
(12) Patent Application Publication
(10) Pub. No.: US 2013/0193169 A1
(43) Pub. Date: Aug. 1, 2013

(54) CONTAINER CAPABLE OF POURING OUT LIQUID IN FIXED QUANTITY

(71) Applicant: Shi PENG, Shenzhen (CN)

(72) Inventor: Shi PENG, Shenzhen (CN)

(21) Appl. No.: 13/831,863

(22) Filed: Mar. 15, 2013

Related U.S. Application Data
(63) Continuation of application No. PCT/CN2012/073107, filed on Mar. 27, 2012.

(30) Foreign Application Priority Data
Apr. 28, 2011 (CN) 201110107439.0

(51) Int. Cl. G01F 11/26

(52) U.S. Cl. CPC G01F 11/262
USPC 222/454

(57) ABSTRACT

A container includes a quantifying device, an upper sealing cover and a container body. The quantifying device includes an external quantifying cup, a fixing portion and a fluid guide port. The quantifying device is disposed on an opening of the container through the fixing portion. Corresponding to a place above the opening of the container, the fluid guide port is disposed on an upper portion of the quantifying device, and a lower portion of the fluid guide port communicates with the container. The quantifying cup communicating with the fluid guide port is disposed on an outer side of the fluid guide port. The volume of a liquid fluid can be accurately measured and a non-metered original solution can be directly poured out, and the metering accuracy is improved during use.

### CROSS REFERENCE TO RELATED APPLICATIONS

This application is a continuation application of PCT/CN2012/073107 filed on Mar. 27, 2012, which claims the benefit of Chinese Patent Application No. 201110107439.0 filed on Apr. 28, 2011; the contents of which are hereby incorporated by reference.

### BACKGROUND

1. Technical Field

The present application relates to a container capable of conveniently measuring volumes of various liquid fluids, and more particularly to a container capable of pouring out a liquid in a fixed quantity or continuously pouring out the liquid.

2. Related Arts

With the continuous improvement of the production and living standards, people use more and more liquid articles every day, so people urgently need a measuring tool for conveniently measuring volumes and weights of the articles. For example, when cooking dishes (especially preparing dishes according to a cookbook), weights of ingredients such as oil and vinegar need to be measured accurately. It is not very accurate to meter and judge the ingredients with naked eye by experience, and the deliciousness of the food is affected to a certain extent. Especially for people unfamiliar with cooking, it is more difficult to judge the quantities of seasonings.

Due to lack of a liquid metering container and package which are convenient to use, have high compatibility and are safe and inexpensive, people mostly perform estimation by experience, thereby bringing much inconvenience to the production and life.

### SUMMARY

### Technical problems

In view of the problem in the prior art, the present application is directed to a container capable of pouring out a liquid in a fixed quantity. The container not only can accurately meter and take a liquid fluid but also can directly pour out a non-metered liquid, so as to achieve compatibility between fixed-quantity taking and indefinite-quantity taking of the container in a simple manner. An external quantifying cup is disposed, so that a user can clearly see a quantity of a liquid in the quantifying cup, and it is convenient for the user to perform an operation on the liquid in the quantifying cup for a second time (for example, pour out only half of the liquid). The external quantifying cup can also collect a residual liquid at an outer edge of the fluid guide port. It is easy to process and form this structure all at once, thereby reducing the manufacturing cost.

### Technical solutions

In order to solve the foregoing technical problem, the present application is implemented through the following technical solutions.

A container capable of pouring out a liquid in a fixed quantity includes a quantifying device, an upper sealing cover and a container body, in which the quantifying device includes an external quantifying cup, a fixing portion and a fluid guide port; the quantifying device is disposed on an opening of the container body through the fixing portion; corresponding to a place above the opening of the container body, the fluid guide port is disposed on an upper portion of the quantifying device, and a lower portion of the fluid guide port communicates with the container body; the external quantifying cup communicating with the fluid guide port is disposed on an outer side of the fluid guide port; a cup wall inversely inclined towards the opening of the container body is disposed at a far end of the external quantifying cup opposite to the fluid guide port, the external quantifying cup is located outside the container body, and an opening portion is disposed at a cup mouth of the external quantifying cup; the upper sealing cover fits an upper opening of the quantifying device; when the upper sealing cover seals the upper opening of the quantifying device, the fluid guide port communicates with the external quantifying cup; and a height of a lowest place of the fluid guide port is not higher than a height of the opening portion of the external quantifying cup.

Preferably, an injection port is disposed on a circumferential wall of the fluid guide port, the injection port communicates with the external quantifying cup, and one, two, or more injection ports may be disposed.

Preferably, a horizontal location of a highest place of the fluid guide port is higher than a horizontal location of the opening portion of the quantifying cup, so that it is convenient for a user to pour out a solution in the container in an indefinite quantity through the fluid guide port.

Preferably, a fluid discharge port of the quantifying cup is disposed on the external quantifying cup, and the fluid discharge port of the quantifying cup is located at the upper opening of the quantifying device.

Preferably, a certain inclined angle exists between the fluid discharge port of the external quantifying cup and the fluid guide port, so that when the container is tilted towards the fluid discharge port of the external quantifying cup, the liquid in the quantifying cup can be preferentially poured out through the fluid guide port and the fluid discharge port of the external quantifying cup, so it is convenient for the user to take the liquid in a fixed quantity.

Preferably, a bottom or a side wall of the external quantifying cup is connected to the quantifying device in a movable manner, such that the volume of the quantifying cup is changeable.

Preferably, a movable slide block is disposed on the injection port, and a height of the injection port is defined by pushing and pulling the slide block, such that the volume of the quantifying cup is changeable.

Preferably, a sealer is disposed on the fluid guide port, and the sealer is an easy-to-open seal or a sealing sheet, so as to hermetically package the liquid in cooperation with the container conveniently.

Preferably, a cross section of the external quantifying cup is a triangle or a trapezoid.

During use, first, the container is tilted to inject a liquid into the quantifying cup when the upper sealing cover is closed, and then, the container is placed upright, and the upper sealing cover is opened, and the container is slightly tilted, so the liquid in a fixed quantity in the quantifying cup is poured out. The tilt angle may also be changed to continuously pour out the liquid directly through the fluid guide port.

The upper sealing cover and the quantifying device may be disposed as an integrated structure or a separated structure.

A container capable of pouring out a liquid in a fixed quantity includes a quantifying device, an upper sealing cover and a container body, in which the quantifying device includes a connection cavity running from top to bottom and an external quantifying cup capable of measuring a liquid, a fluid guide port is disposed on an upper portion of the connection cavity, a lower portion of the connection cavity is fixed to the container body, the external quantifying cup is located outside the container body and the connection cavity, the external quantifying cup integrally extends from the outside of the connection cavity to one side of the connection cavity, so that the external quantifying cup raises from one side of the connection cavity, an opening portion is disposed on an upper portion of the external quantifying cup, the upper sealing cover corresponds to the opening portion and the fluid guide port, so that when the container body is tilted and the upper sealing cover seals the opening portion, the liquid in the container body is capable of flowing into the external quantifying cup through the connection cavity without flowing out of the container, and when the upper sealing cover is opened, the liquid in the container body is capable of flowing out of the container through the fluid guide port or the liquid in the external quantifying cup is capable of flowing out of the container through the opening portion, and a height of a lowest place of the fluid guide port is not higher than a height of the opening portion of the external quantifying cup.

When the upper sealing cover is closed, the upper sealing cover tightly presses against the opening portion of the external quantifying cup, the upper sealing cover is equivalent to another “side wall” of the external quantifying cup, and meanwhile, a gap exists between the upper sealing cover and the fluid guide port. In this case, the container body communicates with the external quantifying cup, and the liquid in the container body is capable of flowing into a “measuring cup” formed by the external quantifying cup and the upper sealing cover for pre-measurement. When the upper sealing cover is opened, the liquid in the external quantifying cup can be discharged via the opening portion through tilting and rotation at different angles, so as to realize taking in a fixed quantity; and the liquid in the external quantifying cup may also be discharged directly through the fluid guide port of the connection cavity, so as to realize taking in an indefinite quantity.

The fluid guide port is surrounded by an annular cylindrical wall. A top end surface of the cylindrical wall is recessed downwards to form an injection port. The injection port communicates with the external quantifying cup. The cylindrical wall is located in an upper portion of the connection cavity. A height of a lowest place of the injection port is not higher than a height of the opening portion of the quantifying cup, that is, a height of a bottom side of the injection port may be equal to or lower than the height of the opening portion. When the liquid in the external quantifying cup exceeds the bottom side of the injection port, the liquid may flow back to the container body through the injection port.

A horizontal location of a highest place of the fluid guide port of the connection cavity is not lower than the opening portion of the external quantifying cup, that is, the fluid guide port may be equal to or higher than the opening portion. When a liquid is taken in an indefinite quantity, the liquid in the container body may be directly poured out through the fluid guide port.

A long diameter of the opening portion of the external quantifying cup is not less than a depth of the external quantifying cup. During pre-measurement, the upper sealing cover is closed, the container is tilted, and the liquid flowing out of the fluid guide port flows into the “measuring cup” jointly formed by the external quantifying cup and the upper sealing cover. When the liquid is poured out, the upper sealing cover is opened, and the external quantifying cup has a large liquid discharging diameter, so it is only necessary to tilt the container at a small angle to discharge the liquid in the external quantifying cup, which is convenient for operations. The long diameter refers to a maximum diameter of the opening portion.

A cup wall inversely inclined towards the opening portion is disposed at one side of the external quantifying cup far away from the connection cavity, so that when the container body is tilted towards a fluid discharge port of the external quantifying cup, the liquid in the quantifying cup can be preferentially poured out through the fluid guide port and the opening portion, so it is convenient for the user to take the liquid in a fixed quantity. Therefore, the external quantifying cup may be of a shape with a big upper part and a small lower part.

The injection port is disposed on the cylindrical wall.

An easy-to-tear sealer or a disposable sealer is disposed on the fluid guide port.

The external quantifying cup has a side wall and a bottom, and at least one of the side wall and the bottom is movable, so that the volume of the external quantifying cup is adjustable.

A movable slide block is disposed in the injection port. A depth of the injection port is defined by pushing or pulling the slide block. When the slide block is moved, the depth of the injection port is changed, so as to change the volume of the external quantifying cup.

The connection cavity, the external quantifying cup and the upper sealing cover are integrally formed.

An assembly capable of pouring out a liquid in a fixed quantity includes a quantifying device and an upper sealing cover, in which the quantifying device includes a connection cavity running from top to bottom and an external quantifying cup capable of measuring a liquid, a fluid guide port is disposed on an upper portion of the connection cavity, a lower portion of the connection cavity is fixed to a container body, the external quantifying cup is located outside the container body and the connection cavity, the external quantifying cup integrally extends from the outside of the connection cavity to one side of the connection cavity, so that the external quantifying cup raises from one side of the connection cavity, an opening portion is disposed on an upper portion of the external quantifying cup, the upper sealing cover corresponds to a fluid discharge port of the quantifying cup and the fluid guide port, so that when the container body is tilted and the upper sealing cover seals the opening portion, the liquid in the container body is capable of flowing into the external quantifying cup through the connection cavity without flowing out of the assembly, and when the upper sealing cover is opened, the liquid in the container body is capable of flowing out of the assembly through the fluid guide port or the liquid in the external quantifying cup is capable of flowing out of the assembly through the opening portion, and a height of a lowest place of the fluid guide port is not higher than a height of the opening portion of the external quantifying cup.

The fluid guide port is surrounded by an annular cylindrical wall. A top end surface of the cylindrical wall is recessed downwards to form an injection port. The injection port communicates with the external quantifying cup. The fluid guide port of the connection cavity is not lower than the opening portion of the external quantifying cup.

### Beneficial Effects

The beneficial effects of the present application are as follows.

1. Liquid fluid can be accurately metered and taken, and non-metered liquid in the container can be directly poured out, so as to achieve compatibility between fixed-quantity taking and indefinite-quantity taking of the container in a simple manner.

2. The quantifying cup is external, so that a user can clearly see a quantity of a liquid in the quantifying cup, and it is convenient for the user to perform an operation on the liquid in the quantifying cup for a second time (for example, pour out only half of the liquid).

3. The quantifying cup is external, so that the opening portion of the container is kept unblocked when a liquid is taken in an indefinite quantity.

4. The fluid guide port not lower than the external quantifying cup is provided, so that it is only necessary to change a tilt angle to continuously take a liquid in an indefinite quantity, which is not affected by the quantifying cup, and meanwhile, the external quantifying cup can collect a residual liquid at an outer edge of the fluid guide port.

5. The external quantifying cup raises from one side, and during pre-measurement, a right angle or an approximately right angle exists between the external quantifying cup and the connection cavity, so that it is convenient for the user to measure and observe the liquid.

6. It is easy to process and form the structure all at once, thereby reducing the manufacturing cost.

### BRIEF DESCRIPTION OF THE DRAWINGS

FIG. 1 is a schematic exploded structural view of Embodiment 1 of a container capable of pouring out a liquid in a fixed quantity of the present application;

FIG. 2 is a schematic sectional structural view of Embodiment 1 of a container capable of pouring out a liquid in a fixed quantity of the present application (the container is in a pre-measurement state; in this case, an upper sealing cover and an external quantifying cup form a “measuring cup”, and the upper sealing cover forms a side wall of the “measuring cup”);

FIG. 3 is a schematic sectional structural view of Embodiment 1 of a container capable of pouring out a liquid in a fixed quantity of the present application (the container is in a state in which the pre-measurement is complete and the container is placed upright);

FIG. 4 is a schematic sectional structural view of Embodiment 1 of a container capable of pouring out a liquid in a fixed quantity of the present application (the container is in a fixed-quantity taking state, that is, a state of pouring out a liquid in the external quantifying cup);

FIG. 5 is a schematic exploded structural view of Embodiment 2 of a container capable of pouring out a liquid in a fixed quantity of the present application;

FIG. 6 is a schematic sectional structural view of Embodiment 2 of a container capable of pouring out a liquid in a fixed quantity of the present application;

FIG. 7 is a schematic exploded structural view of Embodiment 3 of a container capable of pouring out a liquid in a fixed quantity of the present application;

FIG. 8 is a schematic sectional structural view of Embodiment 3 of a container capable of pouring out a liquid in a fixed quantity of the present application;

FIG. 9 is a schematic exploded structural view of Embodiment 4 of a container capable of pouring out a liquid in a fixed quantity of the present application;

FIG. 10 is a schematic sectional structural view of Embodiment 4 of a container capable of pouring out a liquid in a fixed quantity of the present application;

FIG. 11 is a schematic view of a fixed-quantity use state of Embodiment 1 of a container capable of pouring out a liquid in a fixed quantity of the present application;

FIG. 12 is a schematic view of an indefinite-quantity use state of Embodiment 1 of a container capable of pouring out a liquid in a fixed quantity of the present application;

FIG. 13 is a schematic view of an indefinite-quantity use state of Embodiment 3 of a container capable of pouring out a liquid in a fixed quantity of the present application; and

FIG. 14 is a schematic three-dimensional structural view of Embodiment 4 of a container capable of pouring out a liquid in a fixed quantity of the present application.

The meanings of the reference numbers in the drawings are as follows: 1. quantifying device; 2. upper sealing cover; 3. container; 4. opening portion; 5. fixing portion; 6. fluid guide port; 7. external quantifying cup; 8. injection port; 9. fluid discharge port of the quantifying cup; 10. slide block; 11. sealer.

### DETAILED DESCRIPTION OF THE APPLICATION

### Embodiment 1

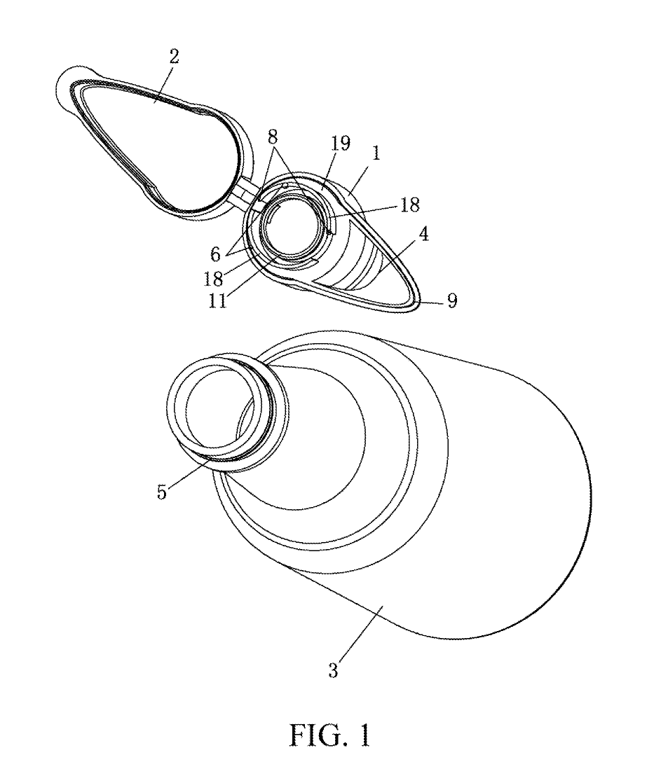

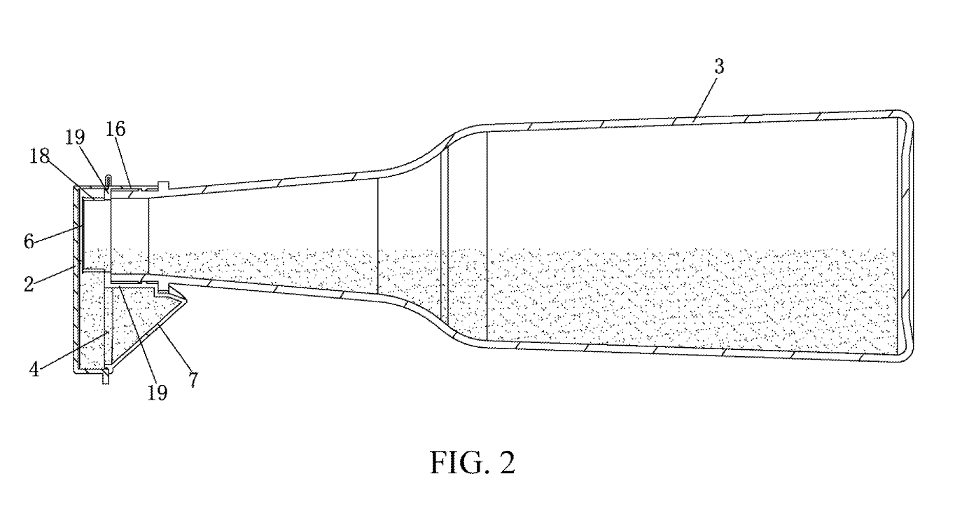

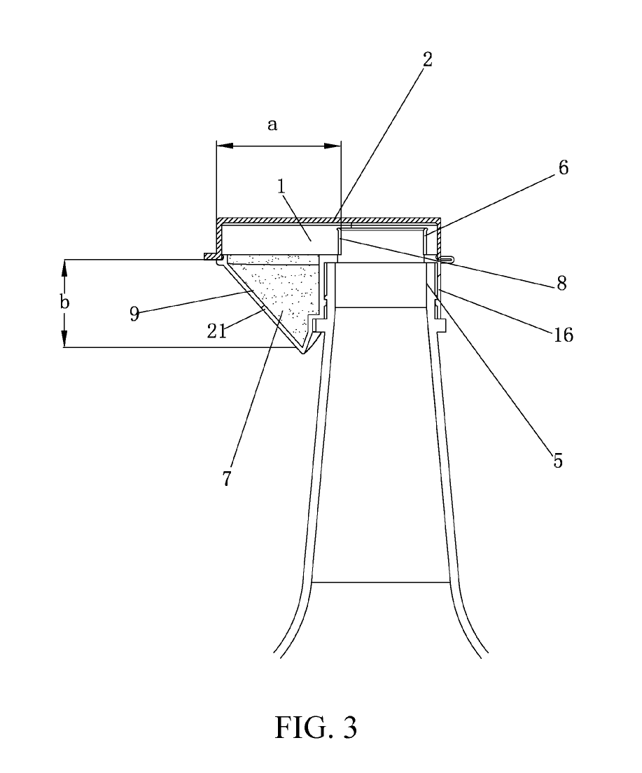

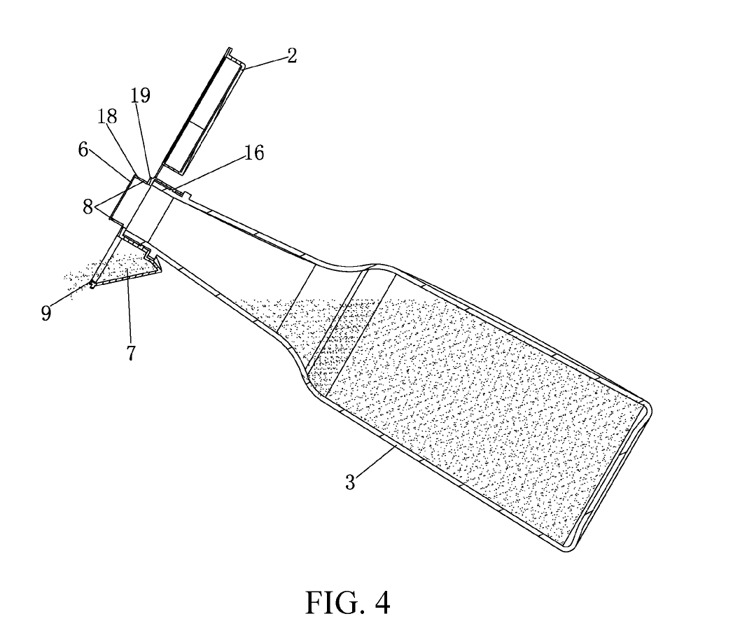

As shown in FIG. 1 to FIG. 4, a container capable of pouring out a liquid in a fixed quantity includes a quantifying device 1, an upper sealing cover 2 and a container body 3. The quantifying device 1 has two injection ports 8, for dividing a fluid guide port 6 into two parts. A horizontal location of a highest place of the fluid guide port 6 is disposed at a place higher than a horizontal location of an opening portion 4 of a quantifying cup, so as to pour out a liquid in the container body 3 in an indefinite quantity. A height of a lowest place of the injection port 8 (a bottom side of the injection port) is equal to or lower than a height of the opening portion 4 of the quantifying cup, so it is convenient for the liquid exceeding the bottom side of the injection port 8 to flow back to the container body 3 when the container is placed upright.

As shown in FIG. 11, during fixed-quantity use, first, the upper sealing cover 2 (the upper sealing cover 2 seals the opening portion 4) may be closed and the container body 3 is tilted, so that a liquid in a fixed quantity is injected into the external quantifying cup 7, and then, the container body 3 is placed upright and the upper sealing cover 2 is opened, and the container is slightly tilted, so that the liquid in a fixed quantity in the external quantifying cup 7 can be poured out through a fluid discharge port 9 of the quantifying cup.

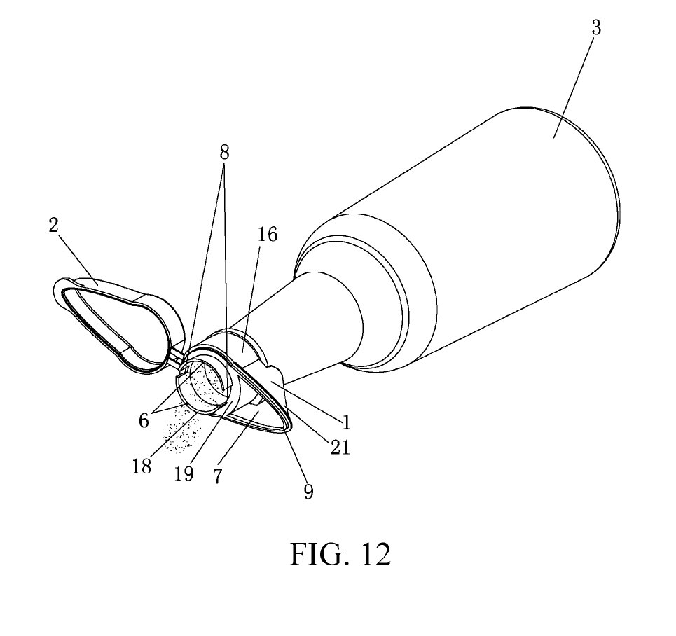

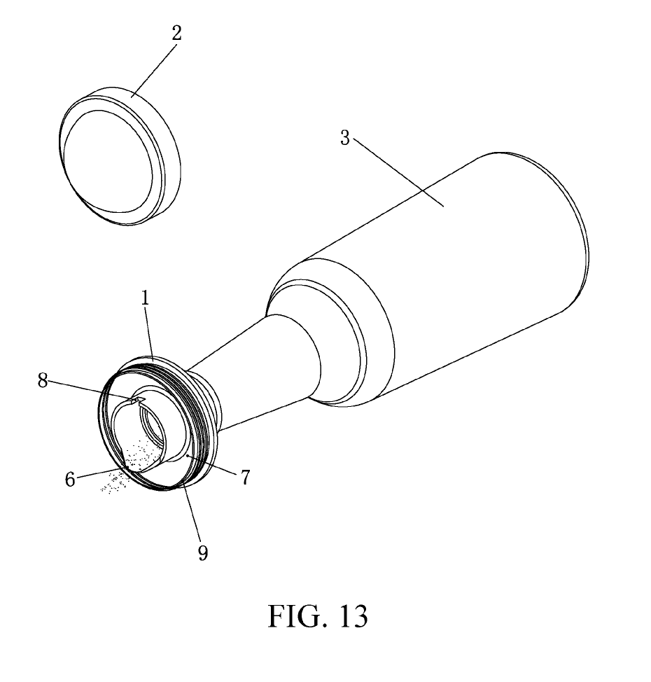

As shown in FIG. 12, during indefinite-quantity use, an angle may also be adjusted to continuously pour out the liquid in the container directly through the fluid guide port 6.

An easy-to-tear sealer 11 is disposed at the fluid guide port 6. Here, the easy-to-tear sealer 11 is an easy-to-open seal. The upper sealing cover 2 and the quantifying device 1 may be of an integrated structure.

In this embodiment, the quantifying device 1 includes the external quantifying cup 7 capable of measuring a liquid and a connection cavity 16 running from top to bottom. The fluid guide port is disposed at an upper portion of the connection cavity 16, which means that the fluid guide port is an upper opening of the connection cavity 16. The upper portion of the connection cavity 16 has an annular end wall 19 and an annular cylindrical wall 18 extending upwards from the end wall 19, that is, the fluid guide port 6 is surrounded by the annular cylindrical wall 18. The injection ports 8 are disposed on the cylindrical wall 18. The two injection ports may be symmetric with respect to an axis of the connection cavity 16, one injection port close to the external quantifying cup, and the other injection port far away from the external quantifying cup. When the container is tilted, the liquid in the connection cavity may flow into the external quantifying cup through the two injection ports.

In this embodiment, the external quantifying cup 7 integrally extends outwards from one side of the connection cavity 16, that is, the external quantifying cup 7 raises from one side of the connection cavity 16.

In this embodiment, a cup wall 21 inversely inclined towards the opening portion is disposed at one side of the external quantifying cup 7 far away from the connection cavity 16.

In this embodiment, a long diameter a of the opening portion 4 of the external quantifying cup is not less than a depth b of the external quantifying cup 7. The long diameter refers to a maximum diameter of the opening portion 4. When the upper sealing cover is closed, the upper sealing cover is combined with the external quantifying cup 7 to jointly form a “measuring cup”. The form of a long “measuring cup” is presented in a direction perpendicular (or approximately perpendicular) to the connection cavity 16. The upper sealing cover becomes a side wall of the “measuring cup”. That is to say, when the upper sealing cover is closed, the upper sealing cover is perpendicular to the connection cavity, or an angle exists between the upper sealing cover and the connection cavity, so that a right angle or an approximately right angle exists between the “measuring cup” formed by the upper sealing cover and the external quantifying cup 7 and the connection cavity, so it is convenient for a user to take and observe a liquid during pre-measurement.

In this embodiment, the external quantifying cup may integrally extend outwards from one side of the connection cavity, and the external quantifying cup and the connection cavity may also be disposed separately and connected together.

In this embodiment, during pre-measurement, a gap may exist between the upper sealing cover 2 and the fluid guide port 6. The upper sealing cover 2 may tightly press against the end wall 19 of the connection cavity 16, and a gap exists between the upper sealing cover 2 and the cylindrical wall 18. Moreover, the upper sealing cover 2 may tightly press against the opening portion 4 of the external quantifying cup. Edges of the opening portion 4 and the end wall 19 may form an upper opening of the container. During pre-measurement, the upper sealing cover 2 seals the upper opening.

### Embodiment 2

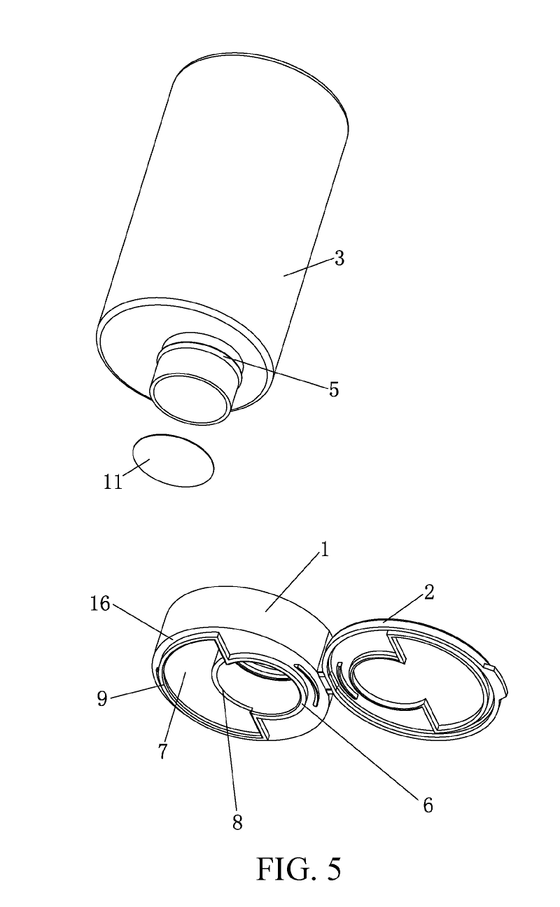

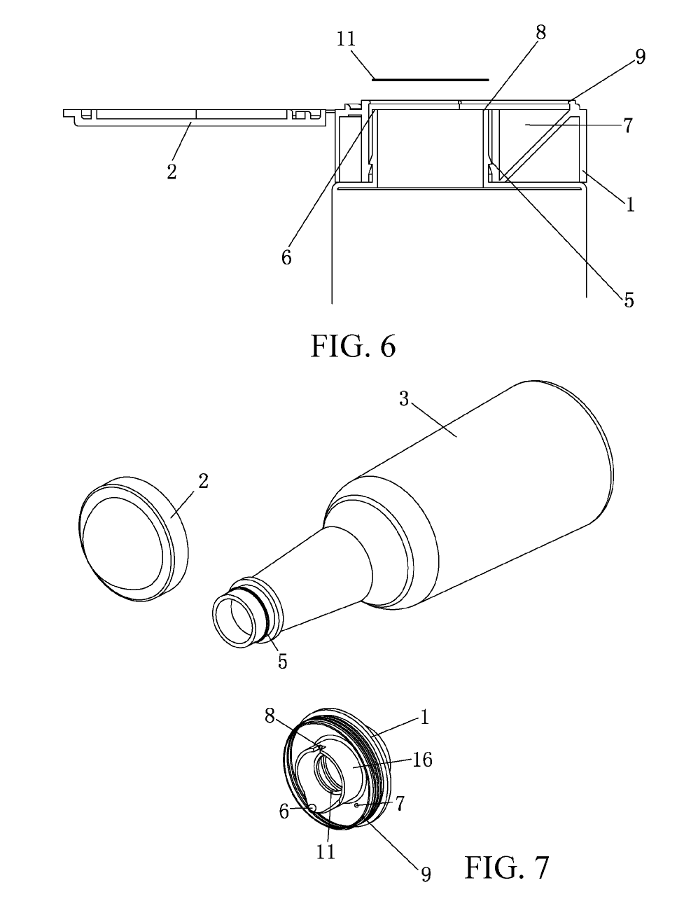

FIG. 5 and FIG. 6 show a container capable of pouring out a liquid in a fixed quantity. A horizontal location of an injection port 8 of a quantifying device 1 and a horizontal location of a fluid guide port 6 coincide horizontally, so that the fluid guide port 6 and an external quantifying cup 7 have equal height in a horizontal direction. During use, first, an upper sealing cover 2 is closed and a container body 3 is tilted, so that a liquid in a fixed quantity is injected into the external quantifying cup 7, and then, the container body 3 is placed upright and the upper sealing cover 2 is opened, and the container is slightly tilted, so the liquid in a fixed quantity in the external quantifying cup 7 is poured out through a fluid discharge port 9 of the quantifying cup. A tilt angle may also be increased to continuously pour out the liquid in the container body directly from the fluid guide port 6.

The upper sealing cover 2 and the quantifying device 1 may be of an integrated structure. An easy-to-tear sealer 11 is also disposed on the fluid guide port 6. Here, the easy-to-tear sealer 11 is a sealing sheet.

In this embodiment, it looks like a part in the connection cavity 16 is dug to form the external quantifying cup 7.

### Embodiment 3

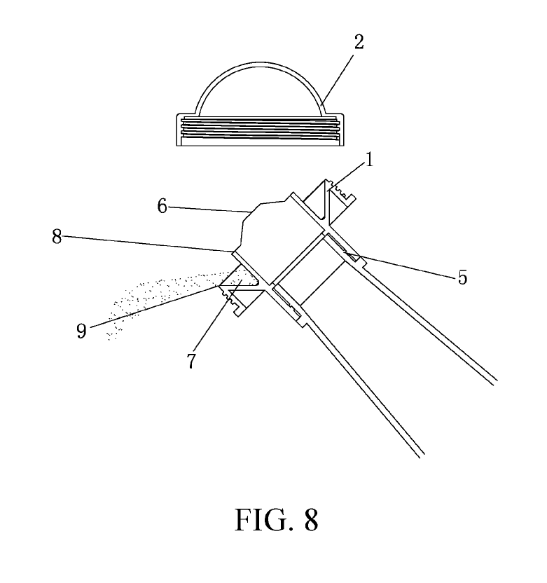

FIG. 7 and FIG. 8 show a container capable of pouring out a liquid in a fixed quantity. An injection port 8 is disposed on a quantifying device 1. A fluid guide port 6 is disposed opposite to the injection port 8. A horizontal location of the fluid guide port 6 is higher than a horizontal location of an external quantifying cup 7. During use, first, an upper sealing cover 2 is closed and a container body 3 is tilted, so that a liquid in a fixed quantity is injected into the external quantifying cup 7, and then, the container body 3 is placed upright and the upper sealing cover 2 is opened, and the container is slightly tilted, so the liquid in a fixed quantity in the external quantifying cup 7 is poured out through a fluid discharge port 9 of the quantifying cup.

As shown in FIG. 13, during indefinite-quantity use, a tilt angle may also be increased to continuously pour out the liquid in the container body 3 directly from the fluid guide port 6. The upper sealing cover 2 is of a separate single body structure and is connected to the quantifying device 1 in a detachable and movable manner.

In this embodiment, the external quantifying cup 7 surrounds the connection cavity 16.

### Embodiment 4

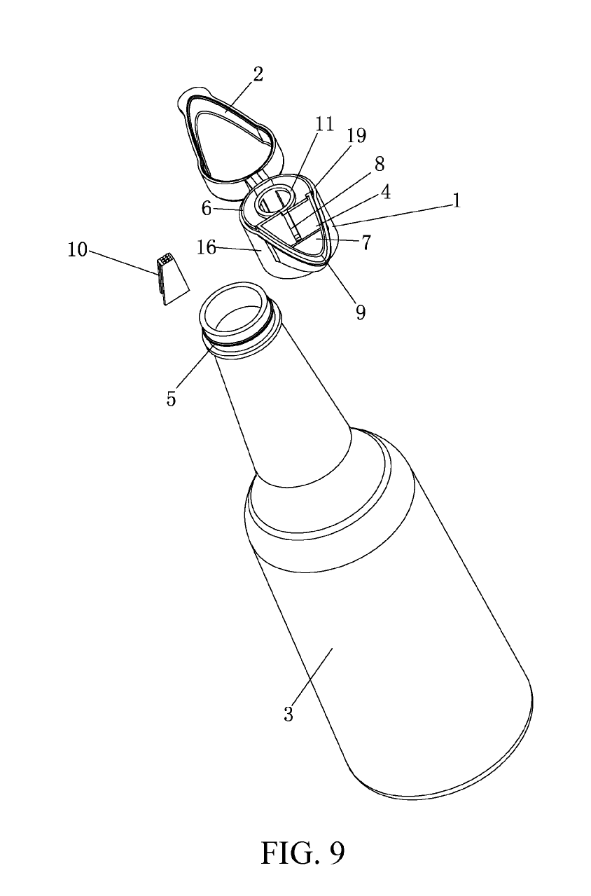

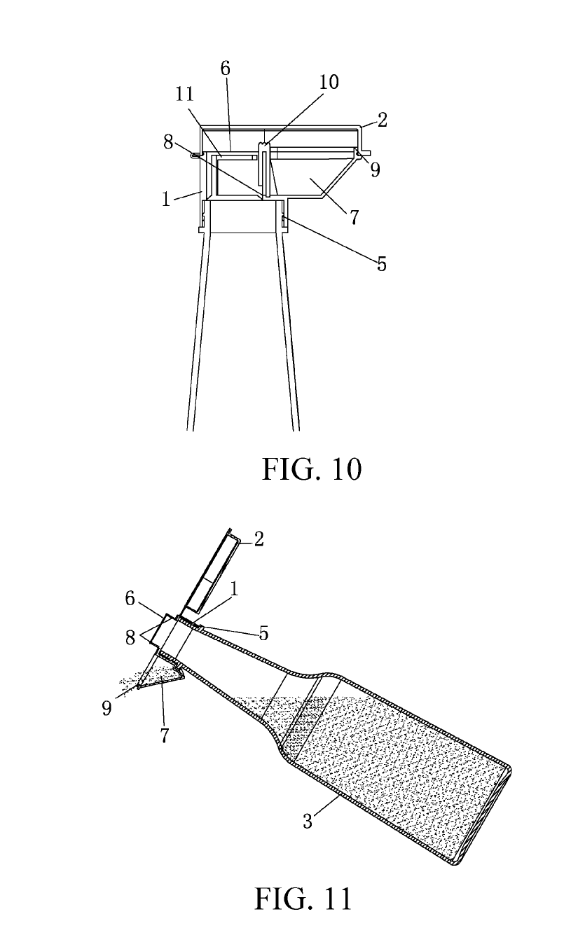

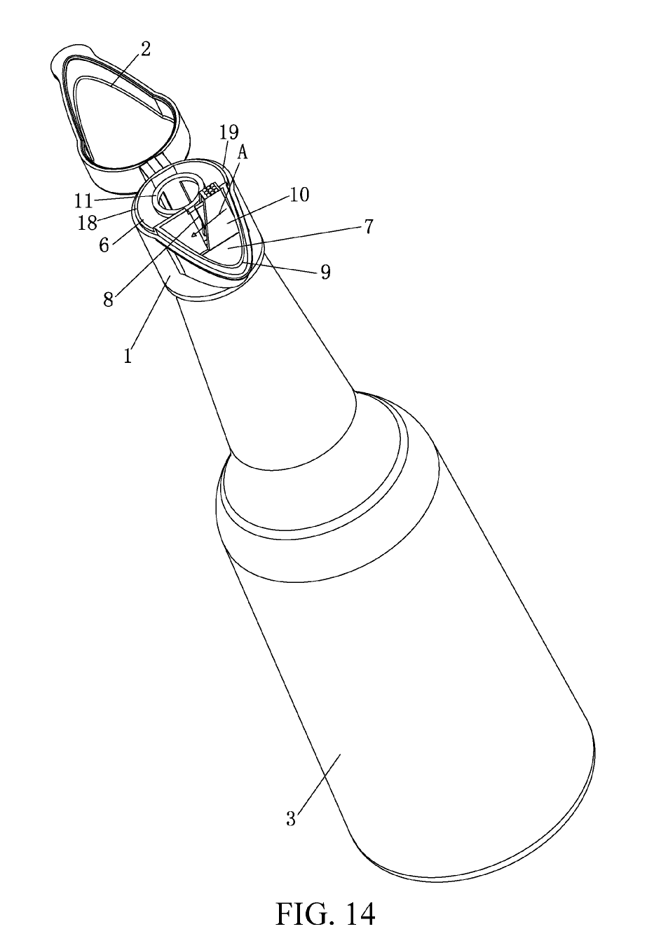

FIG. 9, FIG. 10, and FIG. 14 show a container capable of pouring out a liquid in a fixed quantity. A quantifying device 1 has an injection port 8. A horizontal location of a fluid guide port 6 and a horizontal location of an external quantifying cup 7 have equal height. During use, first, an upper sealing cover 2 is closed and a container body 3 is tilted, so that a liquid is injected into the external quantifying cup 7, and then, the container body 3 is placed upright and the upper sealing cover 2 is opened, and the container is slightly tilted, so the liquid in a fixed quantity in the external quantifying cup 7 is poured out through a fluid discharge port 9 of the quantifying cup. An angle may also be adjusted to continuously pour out the liquid in the container body 3 directly from the fluid guide port 6. A movable slide block 10 is disposed on the injection port 8. One side of the slide block 10 is inclined. A height of the injection port 8 can be defined by pushing or pulling the slide block 10 (in a direction shown by an arrow A in FIG. 14), so as to achieve the purpose of adjusting the volume of the external quantifying cup 7.

In this embodiment, the external quantifying cup 7 integrally extends outwards from one side of a connection cavity 16, that is, the external quantifying cup 7 raises from one side of the connection cavity 16.

In this embodiment, a long diameter of an opening portion 4 of the external quantifying cup is not less than a depth of the external quantifying cup 7. The long diameter refers to a maximum diameter of the opening portion.

In this embodiment, the quantifying device 1 includes the external quantifying cup 7 capable of measuring a liquid and the connection cavity 16 running from top to bottom. The fluid guide port 6 is disposed at an upper portion of the connection cavity 16, which means that the fluid guide port 6 is an upper opening of the connection cavity 16. The opening portion 4 is disposed on an upper portion of the external quantifying cup 7. The opening portion is surrounded by an annular cylindrical wall 18. The annular cylindrical wall 18 integrally extends upwards from an annular end wall 19. The upper sealing cover 2 can seal the fluid guide port 6. When the container body 3 is tilted and the upper sealing cover 2 is in a sealed state, the liquid in the container body 3 can flow into the external quantifying cup 7 through the connection cavity 16 and the opening portion 4.

In this embodiment, during pre-measurement, the upper sealing cover 2 seals the opening portion 4. The upper sealing cover 2 and the external quantifying cup 7 form a “measuring cup”. The upper sealing cover 2 is perpendicular or approximately perpendicular to the connection cavity 16 and constitutes a side wall of the “measuring cup”.

In this embodiment, during pre-measurement, a gap may exist between the upper sealing cover and the fluid guide port of the connection cavity. Moreover, the upper sealing cover may tightly press against the opening portion 4 of the external quantifying cup.

In this embodiment, during pre-measurement, the upper sealing cover 2 seals an upper opening formed by edges of the opening portion 4 and the end wall 19.

Although the present application is described above in further detail through specific embodiments, the present application is not limited to the specific embodiments. It should be understood by persons of ordinary skill in the art that any simple deduction or replacement made without departing from the spirit of the present application shall fall within the protection scope of the present application.

What is claimed is:

1. A container capable of pouring out a liquid in a fixed quantity, comprising a quantifying device, an upper sealing cover and a container body, wherein the quantifying device comprises an external quantifying cup, a fixing portion and a fluid guide port; the quantifying device is disposed on an opening of the container body through the fixing portion; corresponding to a place above the opening of the container body, the fluid guide port is disposed on an upper portion of the quantifying device, and a lower portion of the fluid guide port communicates with the container body; the external quantifying cup communicating with the fluid guide port is disposed on an outer side of the fluid guide port; the external quantifying cup is located outside the container body, and an opening portion is disposed at a cup mouth of the external quantifying cup; the upper sealing cover fits an upper opening of the quantifying device; when the upper sealing cover seals the upper opening of the quantifying device, the fluid guide port communicates with the external quantifying cup; and a height of a lowest place of the fluid guide port is not higher than a height of the opening portion of the external quantifying cup.

2. The container capable of pouring out a liquid in a fixed quantity according to claim 1, wherein an injection port is disposed on a circumferential wall of the fluid guide port, the injection port communicates with the external quantifying cup, and a height of a lowest place of the injection port is not higher than the height of the opening portion of the external quantifying cup.

3. The container capable of pouring out a liquid in a fixed quantity according to claim 2, wherein a horizontal location of a highest place of the fluid guide port is higher than a horizontal location of the opening portion of the external quantifying cup.

4. The container capable of pouring out a liquid in a fixed quantity according to claim 3, wherein a bottom or a side wall of the quantifying cup is connected to the quantifying device in a movable manner.

5. The container capable of pouring out a liquid in a fixed quantity according to claim 1, wherein a sealer is disposed on the fluid guide port, the sealer is an easy-to-open seal or a sealing sheet, and a cup wall inversely inclined towards the opening of the container body is disposed at a far end of the external quantifying cup opposite to the fluid guide port.

6. A container capable of pouring out a liquid in a fixed quantity, comprising a quantifying device, an upper sealing cover and a container body, wherein the quantifying device comprises a connection cavity running from top to bottom and an external quantifying cup capable of measuring a liquid, a fluid guide port is disposed on an upper portion of the connection cavity, a lower portion of the connection cavity is fixed to the container body, the external quantifying cup is located outside the container body and the connection cavity, the external quantifying cup extends from the outside of the connection cavity to one side of the connection cavity, so that the external quantifying cup raises from one side of the connection cavity, an opening portion is disposed on an upper portion of the external quantifying cup, the upper sealing cover corresponds to the opening portion and the fluid guide port, so that when the container body is tilted and the upper sealing cover seals the opening portion, the liquid in the container body is capable of flowing into the external quantifying cup through the connection cavity without flowing out of the container, and when the upper sealing cover is opened, the liquid in the container body is capable of flowing out of the container through the fluid guide port or the liquid in the external quantifying cup is capable of flowing out of the container through the opening portion, and a height of a lowest place of the fluid guide port is not higher than a height of the opening portion of the external quantifying cup.

7. The container capable of pouring out a liquid in a fixed quantity according to claim 6, wherein the fluid guide port is surrounded by an annular cylindrical wall, a top end surface of the cylindrical wall is recessed downwards to form an injection port, the injection port communicates with the external quantifying cup, and a height of a lowest place of the injection port is not higher than the height of the opening portion of the external quantifying cup.

8. The container capable of pouring out a liquid in a fixed quantity according to claim 6, wherein a long diameter of the opening portion of the external quantifying cup is not less than a depth of the external quantifying cup, and a cup wall inversely inclined towards the opening portion is disposed at one side of the external quantifying cup far away from the connection cavity.

9. The container capable of pouring out a liquid in a fixed quantity according to claim 6, wherein an easy-to-tear sealer is disposed on the fluid guide port.

10. An assembly capable of pouring out a liquid in a fixed quantity, comprising a quantifying device and an upper sealing cover, wherein the quantifying device comprises a connection cavity running from top to bottom and an external quantifying cup capable of measuring a liquid, a fluid guide port is disposed on an upper portion of the connection cavity, a lower portion of the connection cavity is fixed to a container body, the external quantifying cup is located outside the container body and the connection cavity, the external quantifying cup integrally extends from the outside of the connection cavity to one side of the connection cavity, so that the external quantifying cup raises from one side of the connection cavity, an opening portion is disposed on an upper portion of the external quantifying cup, the upper sealing cover corresponds to a fluid discharge port of the quantifying cup and the fluid guide port, so that when the container body is tilted and the upper sealing cover seals the opening portion, the liquid in the container body is capable of flowing into the external quantifying cup through the connection cavity without flowing out of the assembly, and when the upper sealing cover is opened, the liquid in the container body is capable of flowing out of the assembly through the fluid guide port or the liquid in the external quantifying cup is capable of flowing out of the assembly through the opening portion, and a height of a lowest place of the fluid guide port is not higher than a height of the opening portion of the external quantifying cup.
